(19) United States
(12) Patent Application Publication
(10) Pub. No.: US 2026/0289971 A1
(43) Pub. Date: Sep. 24, 2026

(54) TARGET OBJECT RECOGNITION METHOD AND APPARATUS, DEVICE, AND MEDIUM

(71) Applicant: Welab Information Technology (shenzhen) Limited., Shenzhen (CN)

(72) Inventors: Huan Sheng, Shenzhen (CN); Cheng Shao, Shenzhen (CN); Huanming Wu, Shenzhen (CN)

(21) Appl. No.: 19/235,663

(22) Filed: Jun. 12, 2025

(30) Foreign Application Priority Data
Mar. 20, 2025 (CN) 202510333737.3

(51) Int. Cl. G06V 10/70; G06T 7/11; G06T 7/13; G06V 10/26; G06V 10/44; G06V 10/75; G06V 10/764; G06V 10/84

(52) U.S. Cl. CPC G06V 10/768; G06T 7/11; G06T 7/13; G06V 10/267; G06V 10/454; G06V 10/76; G06V 10/765; G06V 10/84

(57) ABSTRACT

The present disclosure relates to the technical field of image recognition, and discloses a target object recognition method and apparatus, a device, and a medium. The method includes: acquiring an image to be recognized, and performing initial human body abnormal image recognition on the image to be recognized to obtain an initial recognition result; performing human body pixel segmentation on the image to be recognized according to the initial recognition result to obtain a human body pixel region; performing human body gender recognition on the human body pixel region to obtain a human body gender result corresponding to the image to be recognized; and performing human body nudity recognition on the image to be recognized according to the human body gender result to obtain a target recognition result. The present disclosure may effectively improve the accurate recognition of an image target object.

### CROSS REFERENCE TO RELATED APPLICATIONS

The present application claims the benefit of Chinese Patent Application No. 202510333737.3 filed on Mar. 20, 2025, the contents of which are incorporated herein by reference in their entirety.

### TECHNICAL FIELD

The present disclosure relates to the technical field of image recognition, and more particularly relates to a target object recognition method and apparatus, a device, and a medium.

### BACKGROUND

With the rapid development of the Internet, image information plays an increasingly important role in people’s lives. From the daily lives shared on social media and real scenes on the spot in news reports to the dazzling merchandise display on e-commerce platforms, ubiquitous images have become a key carrier for people to acquire and transmit information. However, there are a large number of human body abnormal images with potential adverse effects on the network (for example, unsightly or even pornographic images, such as vulgar portraits, or sexually explicit images which are wantonly disseminated on some illegal forums), which has adverse effects on social climate and minors.

Conventional image classification methods are often difficult to distinguish different types of images accurately, especially when processing human body images containing complex features such as gender and skin nudity degree. Such methods mostly rely on simple pixel contrast or basic shape recognition, in terms of gender distinction, the simple pixel contrast is vulnerable to illumination, male face shadows increase under strong light, and a pixel gray value changes, thereby being prone to misjudgments in comparison with female images; in dark light, texture details of delicate female skin are lost, so that the distinction degree between females and males decreased sharply; meanwhile, in some fashion show photos, models are in individualistic and avant-garde clothes, part of the skin is exposed, and conventional algorithms are highly prone to misjudgments and difficult to discriminate precisely by confusing such photos with pornographic images, so that there is an opportunity for objectionable images to wantonly spread.

Therefore, how to improve the accurate recognition of image target objects has become a problem demanding prompt solution.

### SUMMARY

The present disclosure provides a target object recognition method and apparatus, a device, and a medium, and a main object of the present disclosure is to solve the technical problem of inaccurate recognition of image target objects.

In a first aspect, in order to achieve the above object, the present disclosure provides a target object recognition method, including:

acquiring an image to be recognized, and performing initial human body abnormal image recognition on the image to be recognized to obtain an initial recognition result;

performing human body pixel segmentation on the image to be recognized according to the initial recognition result to obtain a human body pixel region;

performing human body gender recognition on the human body pixel region to obtain a human body gender result corresponding to the image to be recognized; and

performing human body nudity recognition on the image to be recognized according to the human body gender result to obtain a target recognition result.

In a second aspect, the present disclosure further provides a target object recognition apparatus, including:

an image recognition module configured for acquiring an image to be recognized, and performing initial human body abnormal image recognition on the image to be recognized to obtain an initial recognition result;

a pixel segmentation module configured for performing human body pixel segmentation on the image to be recognized according to the initial recognition result to obtain a human body pixel region;

a gender recognition module configured for performing human body gender recognition on the human body pixel region to obtain a human body gender result corresponding to the image to be recognized; and

a nudity recognition module configured for performing human body nudity recognition on the image to be recognized according to the human body gender result to obtain a target recognition result.

In a third aspect, the present disclosure further provides an electronic device, including:

at least one processor; and

a memory communicatively connected to the at least one processor; wherein

the memory has a computer program executable by the at least one processor stored thereon, and the computer program is executed by the at least one processor to cause the at least one processor to execute the target object recognition method described above.

In a fourth aspect, the present disclosure further provides a computer-readable storage medium having at least one computer program stored therein, wherein the at least one computer program is executed by a processor in an electronic device to implement the target object recognition method described above.

In an example of the present disclosure, Gaussian filtering is performed on an image to be recognized to ensure the high quality and accuracy of the image to be recognized, and a confidence degree threshold is set and secondary recognition processing is performed to recognize a pornographic image and a non-pornographic image more accurately, so as to reduce misjudgments and missed judgments while enhancing the robustness and adaptability of a model; human body pixel segmentation is performed on the image to be recognized according to an initial recognition result, thereby ensuring the accurate extraction of a human body region, reducing the need for manual intervention, improving the efficiency and accuracy of image processing, and providing a reliable data base for subsequent image recognition; by combining with machine learning and image processing technology, human body gender information can be recognized from the image quickly and accurately, thereby improving the accuracy and consistency of recognition while also improving the efficiency of gender recognition; and by combining with the human body gender information, the human body nudity degree in the image to be recognized can be decided more accurately, there is a difference between nudity standards for human bodies with different genders, the acceptability of male and female nudity is different, and targeted nudity recognition is performed according to genders, so as to avoid misjudgments and missed judgments, and improve the accuracy and reliability of recognition.

### BRIEF DESCRIPTION OF THE ACCOMPANYING DRAWINGS

In order to explain the technical solutions of the examples of the present disclosure more clearly, a brief introduction to the accompanying drawings which are required to be used in the description of the examples of the present disclosure will be given below. It is apparent that the drawings in the description below are only some examples of the present disclosure, and for those ordinarily skilled in the art, other drawings may also be obtained according to these drawings without involving any inventive effort.

FIG. 1 is a schematic flow diagram of a target object recognition method provided in an example of the present disclosure;

FIG. 2 is a schematic module diagram of a target object recognition apparatus provided in an example of the present disclosure;

FIG. 3 is a schematic structural diagram of an electronic device implementing the target object recognition method provided in an example of the present disclosure; and

FIG. 4 is another schematic structural diagram of the electronic device implementing the target object recognition method provided in an example of the present disclosure.

The achieved objects, functional characteristics and advantages of the present disclosure will be further explained with reference to the accompanying drawings in conjunction with the examples.

### DETAILED DESCRIPTION OF ILLUSTRATED EMBODIMENTS

In order to enable those skilled in the art to better understand the technical solutions of the present disclosure, and to fully understand and implement the implementation process of how to apply the technical means to solve the technical problems and achieve the corresponding technical effects in the present disclosure, the technical solutions in the examples of the present disclosure will be clearly and completely described below in conjunction with the accompanying drawings in the examples of the present disclosure, and it is apparent that the examples described are only some examples, but not all examples, of the present disclosure. The examples of the present disclosure and various features in the examples may be combined with one another on the premise of no conflict, and the resulting solutions are within the scope of protection of the present disclosure. Based on the examples in the present disclosure, all other examples obtained by those ordinarily skilled in the art without involving any inventive effort should fall within the scope of protection of the present disclosure.

It is noted that the terms “first”, “second”, and the like in the description, claims and the above accompanying drawings of the present disclosure are used for distinguishing between similar objects and not necessarily for describing a particular sequence or chronological order. It should be understood that data used in this way are interchangeable under appropriate circumstances, so that the examples of the present disclosure described herein can be implemented in sequences other than those illustrated or described herein. In addition, the terms “including” and “having”, as well as any variation thereof, are intended to cover a non-exclusive inclusion, for example, a process, method, apparatus, product, or device containing a series of steps or units is not necessarily limited to those steps or units expressly listed, but may include other steps or units not expressly listed or inherent to such process, method, product, or device.

An example of the present application provides a target object recognition method, and an execution subject of the target object recognition method includes, but is not limited to, at least one of electronic devices, such as a server side and a terminal, which can be configured to execute an apparatus provided in the example of the present application. In other words, the target object recognition method may be executed by software or hardware installed in a terminal device or a server side device. The server side includes, but is not limited to: a single server, a server cluster, a cloud server or a cloud server cluster, and the like. The server may be a stand-alone server, and may also be a cloud server providing basic cloud computing services, such as a cloud service, a cloud database, cloud computing, a cloud function, cloud storage, a network service, cloud communication, a middleware service, a domain name service, a security service, a content delivery network (CDN), and a large data and artificial intelligence platform.

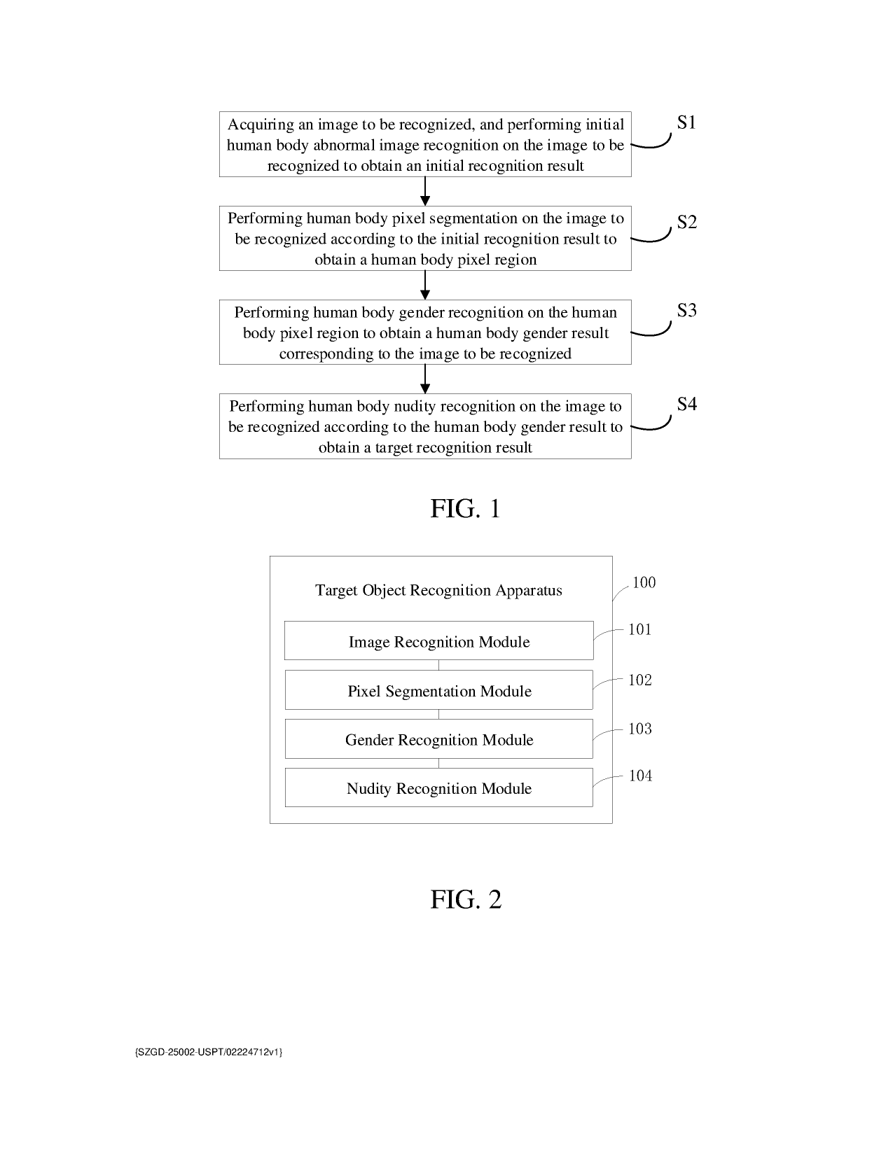

Referring to FIG. 1, FIG. 1 is a schematic flow diagram of a target object recognition method provided in an example of the present disclosure. In this example, the target object recognition method includes:

S1, acquiring an image to be recognized, and performing initial human body abnormal image recognition on the image to be recognized to obtain an initial recognition result.

In the example of the present disclosure, the image to be recognized may be acquired through a preset image database or a relevant website, and initial human body abnormal image recognition is performed on the image to be recognized, including image pre-processing, deep learning technology, and the like, so as to obtain the initial recognition result.

In the example of the present disclosure, a programming language such as python and Java may be utilized to be connected into the preset image database through an HTTP protocol, and an HTTP request is sent to acquire the image to be recognized within a reference time period, so as to obtain the image to be recognized.

In addition, a uniform resource locator of the image database may also be opened by a preset crawler tool, so as to grab the image to be recognized.

In the example of the present disclosure, the performing initial human body abnormal image recognition on the image to be recognized to obtain an initial recognition result, includes:

performing Gaussian filtering on the image to be recognized to obtain a target image to be recognized;

performing image recognition on the target image to be recognized according to a preset pornographic image recognition model to obtain an image confidence degree corresponding to the target image to be recognized; and

utilizing a preset pornographic image confidence degree and a preset normal image confidence degree to be compared with the image confidence degree to obtain the initial recognition result of the image to be recognized.

In detail, Gaussian filtering is performed on the image to be recognized, thereby smoothing the image, reducing noise and improving the accuracy and stability of subsequent recognition. Recognition is performed on the target image to be recognized by utilizing a pre-trained pornographic image recognition model, wherein the pornographic image recognition model is generally constructed based on deep learning technology, such as a convolution neural network (CNN). Features are extracted from the image to be recognized, and whether the image contains pornographic content is decided according to these features. The pornographic image recognition model outputs an image confidence degree, and the probability that the image to be recognized belongs to a pornographic category or a normal category is judged according to the image confidence degree, so as to obtain the initial recognition result.

In the example of the present disclosure, the performing Gaussian filtering on the image to be recognized to obtain a target image to be recognized, includes:

acquiring a preset size and standard deviation of a Gaussian kernel;

generating a Gaussian kernel matrix according to the size and the standard deviation of the Gaussian kernel;

filling edge pixels of the image to be recognized according to the Gaussian kernel matrix to obtain a filled image to be recognized;

performing convolution by utilizing the Gaussian kernel and the filled image to be recognized to obtain a plurality of pixel values; and

aggregating the plurality of pixel values into the target image to be recognized.

In detail, the image to be recognized is denoised by utilizing Gaussian filtering, wherein the size of the Gaussian kernel depends on the required smoothness of the image to be recognized after being denoised and a size of the image to be recognized, the standard deviation of the Gaussian kernel influences the smoothness of the image to be recognized after being denoised, and the larger the standard deviation of the Gaussian kernel is, the better the smoothing effect is. Before the Gaussian filtering is performed on the image to be recognized, the edge pixels of the image to be recognized need to be filled to ensure that the image to be recognized has complete edge pixels, so that the Gaussian kernel can accurately cover all parts of the image to be recognized.

Further, convolution operation is to traverse and fill the image to be recognized with the Gaussian kernel, cover the kernel on a local region of the image to be recognized each time, correspond a central element of the Gaussian kernel matrix to a central pixel of the filled image to be recognized, then perform weighted averaging on the Gaussian kernel matrix and the corresponding pixels in the filled image to be recognized, finally add weighted average results to obtain a plurality of pixel values, namely, convolution results, and aggregate the plurality of pixel values to obtain the target image to be recognized.

In the example of the present disclosure, the utilizing a preset pornographic image confidence degree and a preset normal image confidence degree to be compared with the image confidence degree to obtain the initial recognition result of the image to be recognized, includes:

if the image confidence degree is greater than the preset pornographic image confidence degree, judging that the image to be recognized is a pornographic image;

if the image confidence degree is less than the preset normal image confidence degree, judging that the image to be recognized is a normal image; and

if the image confidence degree is in a range of the preset pornographic image confidence degree and the preset normal image confidence degree, judging that the image to be recognized is a secondary recognition image.

Wherein the secondary recognition image refers to an image to be recognized which is subsequently subjected to human body gender recognition and human body nudity recognition.

In detail, the image confidence degree represents a probability or confidence level that the pornographic recognition model considers that the image to be recognized belongs to a pornographic category, and the image confidence degree is compared with two preset thresholds: one is a preset pornographic image confidence degree threshold for recognizing an image explicitly containing pornographic content, and the other is a preset normal image confidence degree threshold for recognizing an image explicitly containing no pornographic content.

For example, the pornographic image confidence degree threshold is preset to be 0.12, the normal image confidence degree threshold is preset to be 0.06, and if the image confidence degree of the image to be recognized is 0.04, it is judged that the image to be recognized is the normal image; if the image confidence degree of the image to be recognized is 0.20, it is judged that the image to be recognized is the pornographic image; and if the image confidence degree of the image to be recognized is 0.10, subsequent secondary recognition is performed on the image to be recognized.

In the example of the present disclosure, the Gaussian filtering is performed on the image to be recognized to ensure the high quality and accuracy of the image to be recognized, and by setting the confidence degree threshold and performing secondary recognition processing, the pornographic image and the non-pornographic image can be recognized more accurately, thereby reducing misjudgments and missed judgments while enhancing the robustness and adaptability of the model.

S2, performing human body pixel segmentation on the image to be recognized according to the initial recognition result to obtain a human body pixel region.

In the example of the present disclosure, precise human body pixel segmentation is performed on the image to be recognized based on the initial recognition result, and if it is unable to initially judge whether the image to be recognized contains pornographic content, namely, the image to be recognized is the secondary recognition image, the human body pixel segmentation is started, and the human body pixel segmentation utilizes boundary detection technology to quickly lock a suspected human body initial region in the image to be recognized and perform moderate pixel expansion, so as to obtain the human body pixel region and ensure the accuracy and reliability of subsequent recognition.

In the example of the present disclosure, the performing human body pixel segmentation on the image to be recognized according to the initial recognition result to obtain a human body pixel region, includes:

performing boundary scanning on the image to be recognized according to the initial recognition result to obtain a first column boundary and a first row boundary of the human body pixel region;

performing pixel point expansion on the first column boundary and the first row boundary respectively to obtain a second column boundary and a second row boundary of the human body pixel region;

correcting the second column boundary and the second row boundary respectively based on a preset standard width of the human body pixel region to obtain a column segmentation position and a row segmentation position; and

performing human body pixel segmentation on the image to be recognized according to the column segmentation position and the row segmentation position to obtain the human body pixel region.

In detail, boundary scanning is performed on the image to be recognized according to the initial recognition result to initially locate a region which may contain a human body in the image to be recognized, starting boundaries of a pixel set conforming to human body features is obtained by recognition, namely, the first column boundary and the first row boundary, pixel point expansion is performed on the first column boundary and the first row boundary to ensure that human body region can be completely contained and avoid pixel loss due to inaccurate boundary location, for example, one pixel point may be expanded to obtain the second column boundary and the second row boundary of the human body pixel region, and then the second column boundary and the second row boundary are corrected respectively based on the preset standard width of the human body pixel region, so as to obtain the column segmentation position and the row segmentation position of the human body pixel region, and obtain the human body pixel region.

In the example of the present disclosure, the human body pixel segmentation is performed on the image to be recognized according to the initial recognition result, thereby ensuring the accurate extraction of the human body region, reducing the need for manual intervention, improving the efficiency and accuracy of image processing, and providing a reliable data base for subsequent image recognition.

S3, performing human body gender recognition on the human body pixel region to obtain a human body gender result corresponding to the image to be recognized.

In the example of the present disclosure, a deep learning algorithm is utilized to perform convolution pooling processing on the human body pixel region to capture subtle difference features related to genders, dimension compression is performed on the related features to obtain gender eigenvalues of different genders, and normalization is performed according to the gender eigenvalues and a preset gender classification function to obtain the human body gender result of the image to be recognized.

In the example of the present disclosure, the performing human body gender recognition on the human body pixel region to obtain a human body gender result corresponding to the image to be recognized, includes:

converting the human body pixel region into a matrix form to obtain a portrait image matrix;

utilizing a feature extraction network in a preset gender recognition model to perform convolution pooling on the portrait image matrix to obtain a convolution pooling matrix;

performing self-attention weighting on the convolution pooling matrix to obtain a weighted feature matrix;

performing dimension compression on the weighted feature matrix to obtain gender eigenvalues of different genders;

normalizing the gender eigenvalue of each gender according to all the gender eigenvalues and a preset classification function to obtain a gender recognition probability of the corresponding gender; and

determining the human body gender result corresponding to the image to be recognized according to the gender recognition probability.

Wherein the gender recognition model may include an image pre-processing module, a convolution pooling module, and a classification and recognition module, the image pre-processing module refers to performing pre-processing on the image to be recognized, such as denoising, enhancing contrast, and adjusting the size, so as to improve the accuracy and efficiency of subsequent processing; the convolution pooling module refers to utilizing the deep learning algorithm such as a convolution neural network (CNN) to perform convolution pooling on the image to be recognized, and performing operation such as self-attention weighting and dimension compression to obtain gender eigenvalues of different genders; and the classification and recognition module refers to normalizing the gender eigenvalue of each gender according to all the gender eigenvalues and the preset classification function, such as a support vector machine to obtain the gender recognition probability of the corresponding gender, so as to obtain the human body gender result corresponding to the image to be recognized.

In detail, the human body pixel region is converted into a two-dimensional matrix form, namely, a portrait image matrix, and each element in the matrix represents one pixel value in the image; and the feature extraction network (such as the convolution neural network (CNN)) in the preset gender recognition model is used to perform convolution and pooling operation on the portrait image matrix, local features in the portrait image matrix are extracted through the convolution operation, then the dimension of a feature map is reduced through the pooling operation to obtain the convolution pooling matrix, different weights are assigned to each feature for the convolution pooling matrix by utilizing a self-attention mechanism to emphasize features which are more important for gender recognition, the weighted feature matrix is obtained through self-attention weighting, the dimension compression is performed on the weighted feature matrix to reduce the calculation amount and extract key information, so as to obtain the gender eigenvalues representing different genders, and the gender eigenvalues reflect the feature intensities of the human body related to different genders in the human body pixel region.

Further, the gender eigenvalue of each gender is normalized according to all the gender eigenvalues and the preset classification function, such as the support vector machine to obtain the gender recognition probability of the corresponding gender, and the human body gender result corresponding to the image to be recognized is determined according to the gender recognition probability and the preset gender recognition threshold.

For example, the gender recognition threshold may be preset to be 0.5 for deciding whether the gender recognition probability is high enough to determine the gender, and when there is the gender recognition probability greater than the gender recognition threshold, the gender corresponding to the gender recognition probability is determined to be the gender recognition result; and if the gender recognition probabilities of all the genders are not greater than the gender recognition threshold, it indicates that the gender features of the human body in the image to be recognized are not obvious. At this time, all the genders may be summarized as the gender recognition result such as “being unable to determine the gender” or all the genders and the probabilities thereof are listed.

In the example of the present disclosure, by combining with machine learning and image processing technology, the gender information of the human body can be recognized from the image quickly and accurately without manual intervention, thereby improving the accuracy and consistency of recognition while also improving the efficiency of gender recognition.

S4, performing human body nudity recognition on the image to be recognized according to the human body gender result to obtain a target recognition result.

In the example of the present disclosure, a preset nude skin degree detection model is utilized to further analyze the image to be recognized according to the gender recognition result, wherein the nude skin degree detection model may calculate and obtain one nudity score to quantify the nudity degree of the human body in the image to be recognized, and then the target recognition result of the image to be recognized is determined according to a preset nudity threshold and the calculated nudity score.

In the example of the present disclosure, the performing human body nudity recognition on the image to be recognized according to the human body gender result to obtain a target recognition result, includes:

utilizing a preset nude skin degree detection model to determine a nudity score of the image to be recognized; and

determining the target recognition result of the image to be recognized according to a preset nudity threshold and the nudity score based on the human body gender result.

Wherein the nude skin degree detection model may include an image pre-processing module, a feature extraction module, and a classification and recognition module, the image pre-processing module refers to performing pre-processing on the image to be recognized, such as denoising, enhancing contrast, and adjusting the size, so as to improve the accuracy and efficiency of subsequent processing; the feature extraction module refers to utilizing the deep learning algorithm, such as the convolution neural network (CNN) to extract features related to skin, such as color, texture and shape, from the pre-processed image to be recognized, and the nudity score of the nude skin degree of the human body in the image to be recognized is calculated by using a classification algorithm, such as the support vector machine according to the extracted features.

In detail, human body nudity recognition is performed on the image to be recognized by utilizing the nude skin degree detection model to obtain an area of the nude skin in the image to be recognized, namely, a nudity degree, and one nudity score is given, wherein the nudity score is a quantitative index for representing the nudity degree of the human body in the image to be recognized, and the target recognition result of the image to be recognized is determined according to the preset nudity threshold based on the recognized gender result and the calculated nudity score.

In the example of the present disclosure, if the human body gender result is male, the determining the target recognition result of the image to be recognized according to a preset nudity threshold and the nudity score, includes:

deciding whether the nudity score is greater than a preset first nudity threshold;

if the nudity score is greater than or equal to the first nudity threshold, judging that the image to be recognized is the pornographic image; and

if the nudity score is less than the first nudity threshold, judging that the image to be recognized is the normal image.

In the example of the present disclosure, if the human body gender result is female, the determining the target recognition result of the image to be recognized according to a preset nudity threshold and the nudity score, includes:

when the nudity score is greater than or equal to a second nudity threshold, judging that the image to be recognized is the pornographic image;

when the nudity score is less than the second nudity threshold and greater than a third nudity threshold, judging that the image to be recognized is an unsightly image; and

when the nudity score is less than or equal to the third nudity threshold, judging that the image to be recognized is the normal image.

For example, value ranges of both the second nudity threshold and the third nudity threshold are preset to be [0, 1], the second nudity threshold may be 0.60, the third nudity threshold may be 0.40, and if the nudity score of the image to be recognized is 0.80, it is judged that the image to be recognized is the pornographic image; if the nudity score of the image to be recognized is 0.20, it is judged that the image to be recognized is the normal image; and if the nudity score of the image to be recognized is 0.50, the image to be recognized is the unsightly image.

In the example of the present disclosure, by combining with the human body gender information, the human body nudity degree in the image to be recognized can be decided more accurately, there is a difference between nudity standards for human bodies with different genders, the acceptability of male and female nudity is different, and targeted nudity recognition is performed according to genders, so as to avoid misjudgments and missed judgments, and improve the accuracy of recognition.

It should be understood that the magnitude of the sequence number of each step in the above example does not imply the order of execution, and the order of execution of each process should be determined in terms of functionality and inherent logic thereof, and should not constitute any limitation on the implementation process of the example of the present disclosure.

As shown in FIG. 2, FIG. 2 is a functional module diagram of a target object recognition apparatus provided in an example of the present disclosure.

In an example of the present disclosure, a target object recognition apparatus is provided, which is in one-to-one correspondence with the target object recognition method in the above examples. As shown in FIG. 2, the target object recognition apparatus 100 may be installed in an electronic device, and the target object recognition apparatus 100 includes an image recognition module 101, a pixel segmentation module 102, a gender recognition module 103, and a nudity recognition module 104 according to implemented functions. Each functional module is described in detail as follows:

the image recognition module 101 is configured for acquiring an image to be recognized, and performing initial human body abnormal image recognition on the image to be recognized to obtain an initial recognition result;

the pixel segmentation module 102 is configured for performing human body pixel segmentation on the image to be recognized according to the initial recognition result to obtain a human body pixel region;

the gender recognition module 103 is configured for performing human body gender recognition on the human body pixel region to obtain a human body gender result corresponding to the image to be recognized; and

the nudity recognition module 104 is configured for performing human body nudity recognition on the image to be recognized according to the human body gender result to obtain a target recognition result.

In one example, the image recognition module 101, when executing the step of performing initial human body abnormal image recognition on the image to be recognized to obtain an initial recognition result, is configured for:

performing Gaussian filtering on the image to be recognized to obtain a target image to be recognized;

performing image recognition on the target image to be recognized according to a preset pornographic image recognition model to obtain an image confidence degree corresponding to the target image to be recognized; and

utilizing a preset pornographic image confidence degree and a preset normal image confidence degree to be compared with the image confidence degree to obtain the initial recognition result of the image to be recognized.

In one example, the image recognition module 101, when executing the step of performing Gaussian filtering on the image to be recognized to obtain a target image to be recognized, is configured for:

acquiring a preset size and standard deviation of a Gaussian kernel;

generating a Gaussian kernel matrix according to the size and the standard deviation of the Gaussian kernel;

filling edge pixels of the image to be recognized according to the Gaussian kernel matrix to obtain a filled image to be recognized;

performing convolution by utilizing the Gaussian kernel and the filled image to be recognized to obtain a plurality of pixel values; and

aggregating the plurality of pixel values into the target image to be recognized.

In one example, the image recognition module 101, when executing the step of utilizing a preset pornographic image confidence degree and a preset normal image confidence degree to be compared with the image confidence degree to obtain the initial recognition result of the image to be recognized, is configured for:

if the image confidence degree is greater than the preset pornographic image confidence degree, judging that the image to be recognized is a pornographic image;

if the image confidence degree is less than the preset normal image confidence degree, judging that the image to be recognized is a normal image; and

if the image confidence degree is in a range of the preset pornographic image confidence degree and the preset normal image confidence degree, judging that the image to be recognized is a secondary recognition image.

In one example, the pixel segmentation module 102, when executing the step of performing human body pixel segmentation on the image to be recognized according to the initial recognition result to obtain a human body pixel region, is configured for:

performing boundary scanning on the image to be recognized according to the initial recognition result to obtain a first column boundary and a first row boundary of the human body pixel region;

performing pixel point expansion on the first column boundary and the first row boundary respectively to obtain a second column boundary and a second row boundary of the human body pixel region;

correcting the second column boundary and the second row boundary respectively based on a preset standard width of the human body pixel region to obtain a column segmentation position and a row segmentation position; and

performing human body pixel segmentation on the image to be recognized according to the column segmentation position and the row segmentation position to obtain the human body pixel region.

In one example, the gender recognition module 103, when executing the step of performing human body gender recognition on the human body pixel region to obtain a human body gender result corresponding to the image to be recognized, is configured for:

converting the human body pixel region into a matrix form to obtain a portrait image matrix;

utilizing a feature extraction network in a preset gender recognition model to perform convolution pooling on the portrait image matrix to obtain a convolution pooling matrix;

performing self-attention weighting on the convolution pooling matrix to obtain a weighted feature matrix;

performing dimension compression on the weighted feature matrix to obtain gender eigenvalues of different genders;

normalizing the gender eigenvalue of each gender according to all the gender eigenvalues and a preset classification function to obtain a gender recognition probability of the corresponding gender; and

determining the human body gender result corresponding to the image to be recognized according to the gender recognition probability.

In one example, the nudity recognition module 104, when executing the step of performing human body nudity recognition on the image to be recognized according to the human body gender result to obtain a target recognition result, is configured for:

utilizing a preset nude skin degree detection model to determine a nudity score of the image to be recognized; and

determining the target recognition result of the image to be recognized according to a preset nudity threshold and the nudity score based on the human body gender result.

In one example, the nudity recognition module 104, when executing the step of determining the target recognition result of the image to be recognized according to a preset nudity threshold and the nudity score, is configured for:

deciding whether the nudity score is greater than a preset first nudity threshold;

if the nudity score is greater than or equal to the first nudity threshold, judging that the image to be recognized is the pornographic image; and

if the nudity score is less than the first nudity threshold, judging that the image to be recognized is the normal image.

In one example, the nudity recognition module 104, when executing the step of determining the target recognition result of the image to be recognized according to a preset nudity threshold and the nudity score, is configured for:

when the nudity score is greater than or equal to a second nudity threshold, judging that the image to be recognized is the pornographic image;

when the nudity score is less than the second nudity threshold and greater than a third nudity threshold, judging that the image to be recognized is an unsightly image; and

when the nudity score is less than or equal to the third nudity threshold, judging that the image to be recognized is the normal image.

In the present disclosure, for an target object recognition apparatus, Gaussian filtering is performed on an image to be recognized to ensure the high quality and accuracy of the image to be recognized, and a confidence degree threshold is set and secondary recognition processing is performed to recognize a pornographic image and a non-pornographic image more accurately, so as to reduce misjudgments and missed judgments while enhancing the robustness and adaptability of a model; human body pixel segmentation is performed on the image to be recognized according to an initial recognition result, thereby ensuring the accurate extraction of a human body region, reducing the need for manual intervention, improving the efficiency and accuracy of image processing, and providing a reliable data base for subsequent image recognition; by combining with machine learning and image processing technology, human body gender information can be recognized from the image quickly and accurately, thereby improving the accuracy and consistency of recognition while also improving the efficiency of gender recognition; and by combining with the human body gender information, the human body nudity degree in the image to be recognized can be decided more accurately, there is a difference between nudity standards for human bodies with different genders, the acceptability of male and female nudity is different, and targeted nudity recognition is performed according to genders, so as to avoid misjudgments and missed judgments, and improve the accuracy and reliability of recognition. For specific limitation on the target object recognition apparatus, reference may be made to the limitation on the target object recognition method described above, which will not be described in detail herein. Each module in the target object recognition apparatus described above may be completely or partially implemented by software, hardware, or a combination thereof. Each module described above may be embedded in a processor in a computer device in the form of hardware or independent from the processor in the computer device, and may also be stored in a memory in the computer device in the form of software, so as to be convenient for the processor to call and execute operation corresponding to each module described above.

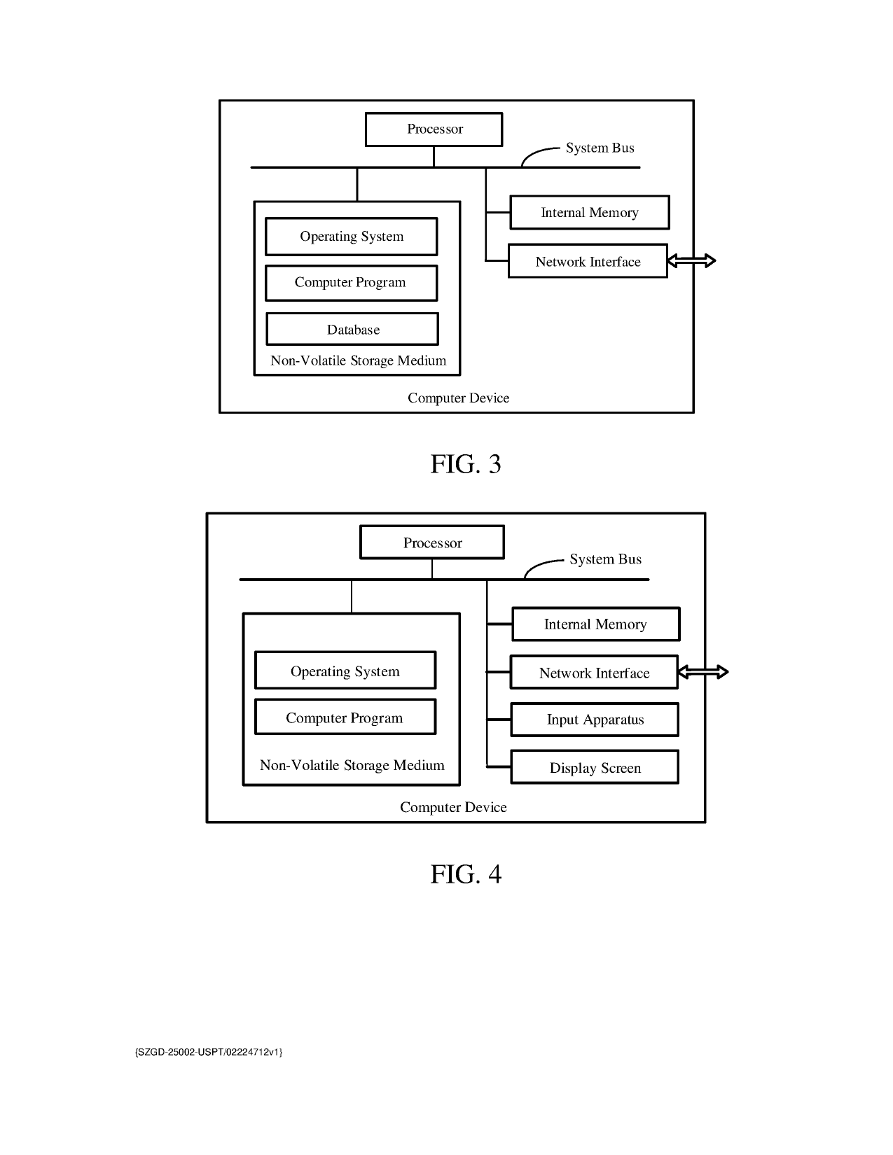

In one example, a computer device is provided, and the computer device may be a server, with an internal structure diagram as shown in FIG. 3. The computer device includes a processor, a memory, a network interface, and a database which are connected by system buses, wherein the processor of the computer device is used for providing calculation and control capabilities. The memory of the computer device includes a non-volatile and/or volatile storage medium, and an internal memory. The non-volatile storage medium stores an operating system, a computer program, and a database. The internal memory provides an environment for running the operating system and the computer program in the non-volatile storage medium. The network interface of the computer device is used for communicating with an external client through network connection. The computer program, when executed by the processor, implements the functions or steps at a server side of the target object recognition method.

In one example, a computer device is provided, and the computer device may be a client, with an internal structure diagram as shown in FIG. 4. The computer device includes a processor, a memory, a network interface, a display screen, and an input apparatus which are connected by system buses, wherein the processor of the computer device is used for providing calculation and control capabilities. The memory of the computer device includes a non-volatile storage medium, and an internal memory. The non-volatile storage medium stores an operating system and a computer program. The internal memory provides an environment for running the operating system and the computer program in the non-volatile storage medium. The network interface of the computer device is used for communicating with an external server through network connection. The computer program, when executed by the processor, implements the functions or steps at a client side of the target object recognition method.

In one example, a computer device is provided, including a memory, a processor, and a computer program stored on the memory and runnable on the processor, wherein the computer program, when executed by the processor, implements the steps of:

acquiring an image to be recognized, and performing initial human body abnormal image recognition on the image to be recognized to obtain an initial recognition result;

performing human body pixel segmentation on the image to be recognized according to the initial recognition result to obtain a human body pixel region;

performing human body gender recognition on the human body pixel region to obtain a human body gender result corresponding to the image to be recognized; and

performing human body nudity recognition on the image to be recognized according to the human body gender result to obtain a target recognition result.

In a plurality of examples provided in the present disclosure, it should be understood that the disclosed device and apparatus may be implemented in other ways. For example, the system examples described above are merely illustrative, for example, the partitioning of the modules is merely the partitioning of logical functions, and there may be other partitioning ways in practical implementation.

In addition, various functional modules in various examples of the present disclosure may be integrated in one processing unit, various units may also be physically present alone, or two or more units may also be integrated in one unit. The above integrated units may be implemented in the form of hardware, or in the form of hardware and software functional modules.

Therefore, the examples should be considered to be illustrative and not restrictive in all respects, the scope of the present disclosure is limited by the appended claims rather than the foregoing description, and thus all changes which are intended to fall within the meaning and scope of equivalents of the claims are included in the present disclosure. Any attached and associated reference numeral in the claims should not be construed as limiting the claim concerned.

For those skilled in the art, it is apparent that the present disclosure is not limited to the details of the foregoing illustrative examples, and that the present disclosure may be implemented in other specific forms without departing from the spirit or basic features of the present disclosure.

In some embodiments of this example, a computer-readable storage medium is provided, having a computer program stored thereon, wherein the computer program, when executed by a processor, implements the steps of the method of the examples described above.

The readable storage medium of the present disclosure has the computer program stored thereon, and the computer program, when executed by the processor of an electronic device, may implement:

acquiring an image to be recognized, and performing initial human body abnormal image recognition on the image to be recognized to obtain an initial recognition result;

performing human body pixel segmentation on the image to be recognized according to the initial recognition result to obtain a human body pixel region;

performing human body gender recognition on the human body pixel region to obtain a human body gender result corresponding to the image to be recognized; and

performing human body nudity recognition on the image to be recognized according to the human body gender result to obtain a target recognition result.

It should be noted that reference may be made to the relevant description of the server side and the client side in the foregoing method examples correspondingly for the above functions or steps which may be implemented by the computer-readable storage medium or the computer device, which will not be described one by one to avoid repetition.

The computer-readable storage medium may also store at least one computer-executable program/instruction, such as a computer-readable instruction. The computer-readable storage media includes, but is not limited to, such as a volatile memory and/or a non-volatile memory. The volatile memory may include, for example, a random access memory (RAM) and/or a cache memory, and the like. The computer-readable storage medium may include, for example, a read-only memory (ROM), a hard disk, a flash memory, and the like. For example, a non-transitory computer-readable storage medium may be connected to a computing device, such as a computer, and then the various methods described above may be performed under the circumstance that the computing device runs the computer-readable instructions stored on the computer-readable storage medium.

In addition, the computer device may further include (but is not limited to) a data bus, an input/output (I/O) bus, a display, and an input/output device (such as a keyboard, a mouse, and a speaker), and the like.

The processor may communicate with an external device via a wired or wireless network through the I/O bus.

In one embodiment, the at least one computer-executable instruction may also be compiled or formed into a software product/computer program product, wherein one or more computer-executable instructions, when run by the processor, execute the steps of various functions and/or methods in the examples described in the art.

It will be understood by those ordinarily skilled in the art that implementing all or part of the flow in the methods of the examples described above may be completed by instructing the associated hardware by the computer program, the computer program may be stored in one non-volatile computer-readable storage medium, and the computer program, when executed, may include, for example, the flow of the example of each method described above, wherein any reference to the memory, storage, the database, or other media used in each example provided in the present application may include the non-volatile and/or volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. As illustration rather than limitation, the RAM is available in many forms such as a static RAM (SRAM), a dynamic RAM (DRAM), a synchronous DRAM (SDRAM), a double data rate SDRAM (DDRSDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM), and the like.

It will clearly understood by those skilled in the art that for the convenience and brevity of description, the division of various functional units and modules described above is merely exemplified, and in practical applications, the above functional allocation may be completed by different functional units and modules according to needs, namely, the internal structure of the system is divided into different functional units or modules, so as to complete all or part of the functions described above. In the examples provided in the present disclosure, it should be understood that the disclosed apparatus and method may also be implemented in other ways. The system examples described above are merely illustrative, for example, the flowchart and the block diagram in the accompanying drawings show the system architecture, functionality, and operation which may be implemented by the apparatus, method, and computer program product according to a plurality of examples of the present disclosure. In this regard, each block in the flowchart or the block diagram may represent a part of a module, program segment or code, which contains one or more executable instructions for implementing the specified logical function. It should also be noted that in some alternative implementation modes, the functions noted in the blocks may also occur out of the order noted in the drawings. For example, two successive blocks may be actually executed substantially in parallel, or sometimes they may also be executed in the reverse order, depending upon the functionality involved. It should also be noted that each block in the block diagram and/or flowchart, and a combination of the blocks in the block diagram and/or flowchart, may be implemented by a special hardware-based system for executing the specified functions or acts, or may be implemented by using a combination of special hardware and computer instructions.

It should be noted that in the present disclosure, the terms “including”, “containing”, or any other variations thereof, are intended to cover a non-exclusive inclusion, so that a process, method, article, or device including a series of elements does not include only those elements but may include other elements not expressly listed or inherent to such process, method, article, or device. An element proceeded by the phrase “including one…” does not, without more constraints, preclude the existence of additional identical elements in the process, method, article, or device including the element.

Although the present disclosure has been described in detail with reference to the foregoing examples, it should be understood by those ordinarily skilled in the art that the technical solutions disclosed in various examples described above may still be modified, or some of the technical features thereof may be replaced by equivalents; and such modification or replacement does not enable the essence of the corresponding technical solutions to depart from the spirit and scope of the technical solutions of various examples of the present disclosure and is intended to be included within the scope of protection of the present disclosure.

It should be noted that the above examples are merely illustrative of the technical solutions of the present disclosure, rather than limiting them. In the examples of the present application, if software tools or components other than those of this company appear, they are merely used for illustrative introduction, and do not represent actual use.

What is claimed is:

1. A target object recognition method, comprising the steps of:
acquiring an image to be recognized, and performing initial human body abnormal image recognition on the image to be recognized to obtain an initial recognition result;
performing human body pixel segmentation on the image to be recognized according to the initial recognition result to obtain a human body pixel region;
performing human body gender recognition on the human body pixel region to obtain a human body gender result corresponding to the image to be recognized; and
performing human body nudity recognition on the image to be recognized according to the human body gender result to obtain a target recognition result.

2. The target object recognition method of claim 1, wherein the step of performing initial human body abnormal image recognition on the image to be recognized to obtain an initial recognition result, comprises:
performing Gaussian filtering on the image to be recognized to obtain a target image to be recognized;
performing image recognition on the target image to be recognized according to a preset pornographic image recognition model to obtain an image confidence degree corresponding to the target image to be recognized; and
utilizing a preset pornographic image confidence degree and a preset normal image confidence degree to be compared with the image confidence degree to obtain the initial recognition result of the image to be recognized.

3. The target object recognition method of claim 2, wherein the step of utilizing a preset pornographic image confidence degree and a preset normal image confidence degree to be compared with the image confidence degree to obtain the initial recognition result of the image to be recognized, comprises:
if the image confidence degree is greater than the preset pornographic image confidence degree, judging that the image to be recognized is a pornographic image;
if the image confidence degree is less than the preset normal image confidence degree, judging that the image to be recognized is a normal image; and
if the image confidence degree is in a range of the preset pornographic image confidence degree and the preset normal image confidence degree, judging that the image to be recognized is a secondary recognition image.

4. The target object recognition method of claim 1, wherein the step of performing human body pixel segmentation on the image to be recognized according to the initial recognition result to obtain a human body pixel region, comprises:
performing boundary scanning on the image to be recognized according to the initial recognition result to obtain a first column boundary and a first row boundary of the human body pixel region;
performing pixel point expansion on the first column boundary and the first row boundary respectively to obtain a second column boundary and a second row boundary of the human body pixel region;
correcting the second column boundary and the second row boundary respectively based on a preset standard width of the human body pixel region to obtain a column segmentation position and a row segmentation position; and
performing human body pixel segmentation on the image to be recognized according to the column segmentation position and the row segmentation position to obtain the human body pixel region.

5. The target object recognition method of claim 1, wherein the step of performing human body gender recognition on the human body pixel region to obtain a human body gender result corresponding to the image to be recognized, comprises:
converting the human body pixel region into a matrix form to obtain a portrait image matrix;
utilizing a feature extraction network in a preset gender recognition model to perform convolution pooling on the portrait image matrix to obtain a convolution pooling matrix;
performing self-attention weighting on the convolution pooling matrix to obtain a weighted feature matrix;
performing dimension compression on the weighted feature matrix to obtain gender eigenvalues of different genders;
normalizing the gender eigenvalue of each gender according to all the gender eigenvalues and a preset classification function to obtain a gender recognition probability of the corresponding gender; and
determining the human body gender result corresponding to the image to be recognized according to the gender recognition probability.

6. The target object recognition method of claim 1, wherein the step of performing human body nudity recognition on the image to be recognized according to the human body gender result to obtain a target recognition result, comprises:
utilizing a preset nude skin degree detection model to determine a nudity score of the image to be recognized; and
determining the target recognition result of the image to be recognized according to a preset nudity threshold and the nudity score based on the human body gender result.

7. The target object recognition method of claim 6, wherein the step of determining the target recognition result of the image to be recognized according to a preset nudity threshold and the nudity score, comprises:
deciding whether the nudity score is greater than a preset first nudity threshold;
if the nudity score is greater than or equal to the first nudity threshold, judging that the image to be recognized is the pornographic image; and
if the nudity score is less than the first nudity threshold, judging that the image to be recognized is the normal image.

8. An electronic device, comprising: a memory and a processor, wherein the processor is electrically connected to the memory, the memory has a computer program executable by the at least one processor stored thereon, and the computer program, when executed by the at least one processor, causes the at least one processor to execute the steps of:
acquiring an image to be recognized, and performing initial human body abnormal image recognition on the image to be recognized to obtain an initial recognition result;
performing human body pixel segmentation on the image to be recognized according to the initial recognition result to obtain a human body pixel region;
performing human body gender recognition on the human body pixel region to obtain a human body gender result corresponding to the image to be recognized; and
performing human body nudity recognition on the image to be recognized according to the human body gender result to obtain a target recognition result.

9. The electronic device of claim 8, wherein the step of performing initial human body abnormal image recognition on the image to be recognized to obtain an initial recognition result, comprises:
performing Gaussian filtering on the image to be recognized to obtain a target image to be recognized;
performing image recognition on the target image to be recognized according to a preset pornographic image recognition model to obtain an image confidence degree corresponding to the target image to be recognized; and
utilizing a preset pornographic image confidence degree and a preset normal image confidence degree to be compared with the image confidence degree to obtain the initial recognition result of the image to be recognized.

10. The electronic device of claim 9, wherein the step of utilizing a preset pornographic image confidence degree and a preset normal image confidence degree to be compared with the image confidence degree to obtain the initial recognition result of the image to be recognized, comprises:
if the image confidence degree is greater than the preset pornographic image confidence degree, judging that the image to be recognized is a pornographic image;
if the image confidence degree is less than the preset normal image confidence degree, judging that the image to be recognized is a normal image; and
if the image confidence degree is in a range of the preset pornographic image confidence degree and the preset normal image confidence degree, judging that the image to be recognized is a secondary recognition image.

11. The electronic device of claim 8, wherein the step of performing human body pixel segmentation on the image to be recognized according to the initial recognition result to obtain a human body pixel region, comprises:
performing boundary scanning on the image to be recognized according to the initial recognition result to obtain a first column boundary and a first row boundary of the human body pixel region;
performing pixel point expansion on the first column boundary and the first row boundary respectively to obtain a second column boundary and a second row boundary of the human body pixel region;
correcting the second column boundary and the second row boundary respectively based on a preset standard width of the human body pixel region to obtain a column segmentation position and a row segmentation position; and
performing human body pixel segmentation on the image to be recognized according to the column segmentation position and the row segmentation position to obtain the human body pixel region.

12. The electronic device of claim 8, wherein the step of performing human body gender recognition on the human body pixel region to obtain a human body gender result corresponding to the image to be recognized, comprises:
converting the human body pixel region into a matrix form to obtain a portrait image matrix;
utilizing a feature extraction network in a preset gender recognition model to perform convolution pooling on the portrait image matrix to obtain a convolution pooling matrix;
performing self-attention weighting on the convolution pooling matrix to obtain a weighted feature matrix;
performing dimension compression on the weighted feature matrix to obtain gender eigenvalues of different genders;
normalizing the gender eigenvalue of each gender according to all the gender eigenvalues and a preset classification function to obtain a gender recognition probability of the corresponding gender; and
determining the human body gender result corresponding to the image to be recognized according to the gender recognition probability.

13. The electronic device of claim 8, wherein the step of performing human body nudity recognition on the image to be recognized according to the human body gender result to obtain a target recognition result, comprises:
utilizing a preset nude skin degree detection model to determine a nudity score of the image to be recognized; and
determining the target recognition result of the image to be recognized according to a preset nudity threshold and the nudity score based on the human body gender result.

14. The electronic device of claim 13, wherein the step of determining the target recognition result of the image to be recognized according to a preset nudity threshold and the nudity score, comprises:
deciding whether the nudity score is greater than a preset first nudity threshold;
if the nudity score is greater than or equal to the first nudity threshold, judging that the image to be recognized is the pornographic image; and
if the nudity score is less than the first nudity threshold, judging that the image to be recognized is the normal image.

15. A non-volatile computer-readable storage medium having a computer program stored thereon, wherein the computer program, when executed by one or more processors, causes the one or more processors to execute the steps of:
acquiring an image to be recognized, and performing initial human body abnormal image recognition on the image to be recognized to obtain an initial recognition result;
performing human body pixel segmentation on the image to be recognized according to the initial recognition result to obtain a human body pixel region;
performing human body gender recognition on the human body pixel region to obtain a human body gender result corresponding to the image to be recognized; and
performing human body nudity recognition on the image to be recognized according to the human body gender result to obtain a target recognition result.

16. The non-volatile computer-readable storage medium of claim 15, wherein the step of performing initial human body abnormal image recognition on the image to be recognized to obtain an initial recognition result, comprises:
performing Gaussian filtering on the image to be recognized to obtain a target image to be recognized;
performing image recognition on the target image to be recognized according to a preset pornographic image recognition model to obtain an image confidence degree corresponding to the target image to be recognized; and
utilizing a preset pornographic image confidence degree and a preset normal image confidence degree to be compared with the image confidence degree to obtain the initial recognition result of the image to be recognized.

17. The non-volatile computer-readable storage medium of claim 16, wherein the step of utilizing a preset pornographic image confidence degree and a preset normal image confidence degree to be compared with the image confidence degree to obtain the initial recognition result of the image to be recognized, comprises:
if the image confidence degree is greater than the preset pornographic image confidence degree, judging that the image to be recognized is a pornographic image;
if the image confidence degree is less than the preset normal image confidence degree, judging that the image to be recognized is a normal image; and
if the image confidence degree is in a range of the preset pornographic image confidence degree and the preset normal image confidence degree, judging that the image to be recognized is a secondary recognition image.

18. The non-volatile computer-readable storage medium of claim 15, wherein the step of performing human body pixel segmentation on the image to be recognized according to the initial recognition result to obtain a human body pixel region, comprises:
performing boundary scanning on the image to be recognized according to the initial recognition result to obtain a first column boundary and a first row boundary of the human body pixel region;
performing pixel point expansion on the first column boundary and the first row boundary respectively to obtain a second column boundary and a second row boundary of the human body pixel region;
correcting the second column boundary and the second row boundary respectively based on a preset standard width of the human body pixel region to obtain a column segmentation position and a row segmentation position; and
performing human body pixel segmentation on the image to be recognized according to the column segmentation position and the row segmentation position to obtain the human body pixel region.

19. The non-volatile computer-readable storage medium of claim 15, wherein the step of performing human body gender recognition on the human body pixel region to obtain a human body gender result corresponding to the image to be recognized, comprises:
converting the human body pixel region into a matrix form to obtain a portrait image matrix;
utilizing a feature extraction network in a preset gender recognition model to perform convolution pooling on the portrait image matrix to obtain a convolution pooling matrix;
performing self-attention weighting on the convolution pooling matrix to obtain a weighted feature matrix;
performing dimension compression on the weighted feature matrix to obtain gender eigenvalues of different genders;
normalizing the gender eigenvalue of each gender according to all the gender eigenvalues and a preset classification function to obtain a gender recognition probability of the corresponding gender; and
determining the human body gender result corresponding to the image to be recognized according to the gender recognition probability.

20. The non-volatile computer-readable storage medium of claim 15, wherein the step of performing human body nudity recognition on the image to be recognized according to the human body gender result to obtain a target recognition result, comprises:
utilizing a preset nude skin degree detection model to determine a nudity score of the image to be recognized; and
determining the target recognition result of the image to be recognized according to a preset nudity threshold and the nudity score based on the human body gender result.
